(19) United States
(12) Patent Application Publication
(10) Pub. No.: US 2014/0136333 A1
(43) Pub. Date: May 15, 2014

(54) Cross Device Identity Generator

(71) Applicant: MICROSOFT CORPORATION, Redmond, WA (US)

(72) Inventors: Igor Shoshitaishvili, Bellevue, WA (US); Siddhartha Roy, Kirkland, WA (US); Euan Grant, Redmond, WA (US); Shan Li, Bellevue, WA (US)

(73) Assignee: MICROSOFT CORPORATION, Redmond, WA (US)

(21) Appl. No.: 13/677,728

(22) Filed: Nov. 15, 2012

(51) Int. Cl. G06Q 30/02

(52) U.S. Cl. CPC G06Q 30/0269
USPC 705/14.66

(57) ABSTRACT

Systems and methods for providing effective and targeted advertisements to consumers through the generations and use of personas and family identities. A persona relates to a user and a contextual environment associated with the user. The personas allow advertisers to provide advertisements related to the contextual environment of a persona. A family identity relates to a set of users associated with at least one device. The family identities allow advertisers to provide advertisements applicable to a set of users.

### BACKGROUND

The consumption of digital media is fragmented over multiple devices such as a personal computer, phone, tablet and television. Consumption of digital media across the various devices makes it challenging for advertisers to provide effective advertising to a consumer. In addition to the consumption of digital media being fragmented over multiple devices, the consumption of digital media is fragmented over multiple users on one device. For instance, multiple users may be associated with one game console. The association of multiple users on one device makes it challenging for advertisers to provide effective advertising to a consumer. For instance, an advertiser may provide an advertisement over a gaming console that is applicable to a child user when it is actually an adult user that is signed onto the gaming console.

### SUMMARY

Embodiments of the present invention relate to delivering effective advertisements to an audience by developing a family identity associated with at least two users of a device and determining whether to provide an advertisement targeted to an individual user or a family identity. Further, embodiments of the present invention relate to tracking advertisements that have been previously presented to an audience and defining a subset of advertisements to present to the same audience, where such subset includes advertisements not previously presented.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is illustrated by way of example and not limitation in the accompanying figures in which like references numerals indicate similar elements and in which:

FIG. 1 is a block diagram of an exemplary computing system environment suitable for use in implementing embodiments of the present invention;

FIG. 2 is a schematic diagram of an exemplary persona system in which embodiments of the present invention may be employed;

FIG. 3 is a schematic diagram of exemplary contextual environments in which embodiments of the invention may be employed;

FIG. 4 is a schematic diagram depicting an exemplary family identity system in which embodiments of the present invention may be employed;

FIG. 5 is a schematic diagram depicting an exemplary home environment in which embodiments of the present invention may be employed;

FIG. 6 is a schematic diagram of an exemplary applicable target advertising system in which embodiments of the present invention may be employed;

FIG. 7, is a flow diagram illustrating a method for generating a cross-device personal identity, in accordance with an embodiment of the present invention;

FIG. 8 is a flow diagram illustrating a method for generating a family identity, in accordance with an embodiment of the present invention;

FIG. 9 is a flow diagram illustrating a method for generating a family identity, in accordance with an embodiment of the present invention; and

FIG. 10 is a diagram illustrating a relationship between family identities, personal identities, and personas, in accordance with an embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer readable media for providing effective advertisements to an audience based on personas, personal identities, and family identities. A personal identity may be associated with multiple devices associated with a user. A family identity may be associated with devices uses by members of the family and include an indication whether or not a particular device is shared or personal. Utilizing embodiments of the present invention, advertisers are able to deliver advertisements to consumers that have not been previously presented to a consumer on any device associated with a personal or family identity. Advertisers are also able to deliver advertisements to a consumer that correlate with a contextual environment associated with the consumer. Additionally, in instances where the identity of a user is unclear, advertisers may be able to deliver advertisements targeted to a family identity, where the family identity correlates to a set of users.

Embodiments in the present invention generate personal identities and relate multiple personal identities together under a family identity. The personal identity is associated with a single user of one or more computing devices. A personal identity seeks to aggregate a person's online activities and identities with under a single identity for information gathering purposes. For example, a single user may have multiple email addresses, belong to multiple social networks, and have various user IDs for any number of online websites. Online data may be analyzed to determine that all of the online identities and activities are associated with the same user and associate the IDs and activities together as a personal identify. Various information is analyzed to form a personal identity. For example, user IDs entered at various websites from the same browser and IP address may be group together to form a personal identity. Other factors may also be considered to increase the confidence that the user activities and IDs should be associated with a single personal identity.

The name of the user associated with the personal identity may be unknown. A personal identity may be anonymous, meaning that the personally identifiable information for the user is unknown, or intentionally obscured. However, in some embodiments, the person associated with the personal identity is known. In one embodiment, the person explicitly creates a personal identity and associates online identities with the personal identity.

A personal identity may be associated with personas that group user activities together by theme. For example, a personal identity could have a work persona, a home persona, and a shopping persona. Each persona could be associated with a device, IP address, geo location, and time of day or days. For example, the work persona could be associated with an IP address at a work place and a time of day. These characteristics of the persona can be evaluated subsequently to ascertain whether the user is engaging in activities presently associated with a particular persona. Once the persona is identified, advertisements may be directed to the user based on the persona.

The user's present activity does not need to match all of the characteristics in a particular persona for the persona to be selected as the active persona. For example, a persona could be associated with a home IP address and a home or personal computing device but engage in the type of activity that is associated with the work persona. For example, the user could be engaging in search activity consistent with work related queries.

Multiple personal identities can be associated with a single family identity. Personal identities may be connected to a particular family in a variety of ways. In one embodiment, two personal identities are connected to a family identity through a shared computing device. For example, data received from a laptop computer could be analyzed to ascertain that a first personal identity and a second personal identity both use the computing device. For example, a first personal identity could log into an email account and a short time later a second personal identity could log in to a second email account from the laptop

Signal overlap could occur between the first and second personal identity described previously further increasing confidence that the first identity and the second identity should be grouped into a family identity. For example, the smart phones associated with the first and second personal identity respectively may both access a website using the same IP address when the users use a Wi-Fi network behind the same wireless router. Different methods of associating of personal identities and family identities will be described in more detail subsequently.

In addition to grouping personal identities into a family, a personal identity may be associated with multiple devices. For example, a personal identity may be associated with a smart phone and a laptop. The laptop may be shared device, as mentioned before, while the smart phone is a personal device that is not shared. Embodiments of the present invention, associate a personal identity with multiple devices and family identities with multiple devices associated with family members.

Accordingly, one embodiment of the present invention is directed to one or more computer-readable media having computer-executable instructions embodied thereon that, when executed, perform a computer-implemented method for generating a cross-device personal identity. The method includes receiving online activity data (“data”) associated with multiple devices and users. Determining that a first device and a second device are both associated with a first personal identity because a common signal within the data is received from both the first device and the second device and the first personal identity is an aggregation of online identities associated with a single user. The method includes, using online data associated with the first device and the second device, generating a persona for the first personal identity where the persona describing patterns of actions having a common theme.

In another embodiment, the present invention is directed to one or more computer-readable media having computer-executable instructions embodied thereon that, when executed, perform a computer-implemented method for generating a family identity. The method includes receiving online activity data (“data”) associated with multiple devices and users. Analyzing the data to identify a plurality of personal identities including a first personal identity and a second personal identity, where a personal identity represents an aggregation of online identities for a user. The method includes generating the family identity comprising the first personal identity and the second personal identity by identifying a signal within the data that indicate the first personal identity and the second personal identity are related.

In yet another embodiment, the present invention is directed to a method for generating a family identity. The method includes receiving online activity data (“data”) associated with multiple devices and users. Generating the family identity that comprises multiple personal identities being associated with each other through the data. The method includes determining a level of confidence that a device associated with the family identity is presently being shared and upon determining the level of confidence is above a threshold, using the family identity to select advertisements for display on the device.

Having briefly described an overview of embodiments of the present invention, an exemplary operating environment in which embodiments of the present invention may be implemented is described below in order to provide a general context for various aspects of the present invention.

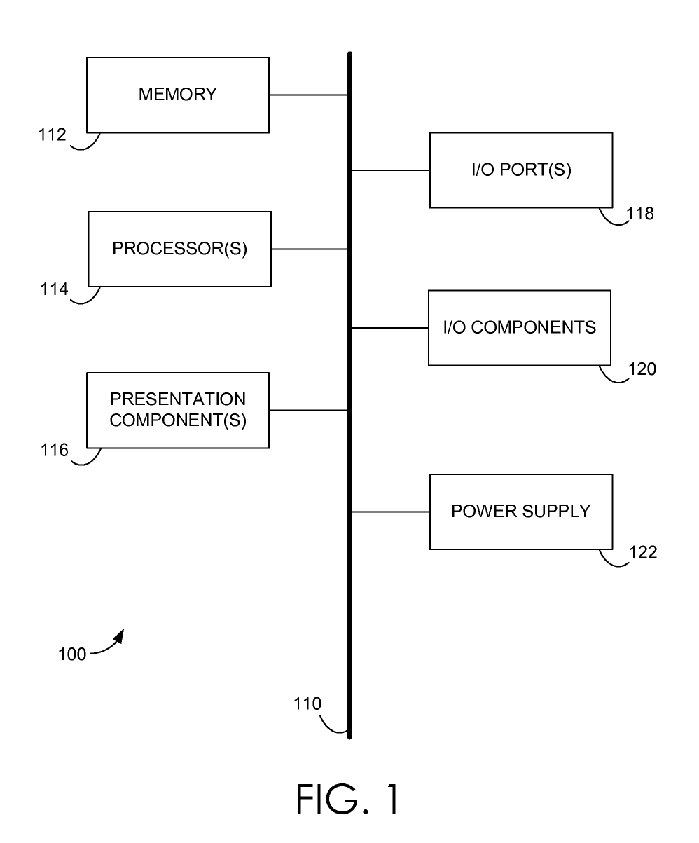

Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network.

In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

With continued reference to FIG. 1, computing device 100 includes a bus 110 that directly or indirectly couples the following elements: memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

The computing device 100 typically includes a variety of computer-readable media. Computer-readable media can be any available media that can be accessed by the computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer storage media in the form of volatile and/or nonvolatile memory. The memory may be removable, non-removable, or a combination thereof. Exemplary hardware devices include solid state memory, hard drives, optical disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, etc.

As previously mentioned, embodiments of the present invention are generally directed to systems, methods and computer-readable media for, among other things, facilitating targeted advertising through generating personas and family identities and determining an applicable advertisement target.

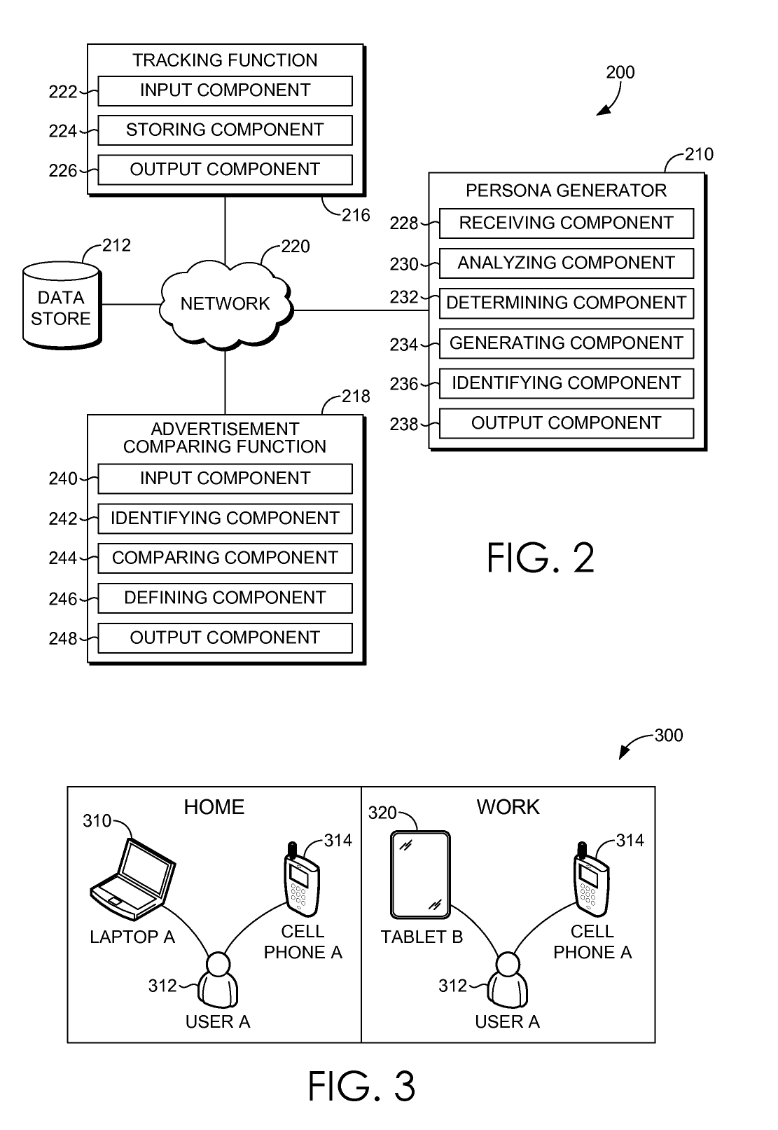

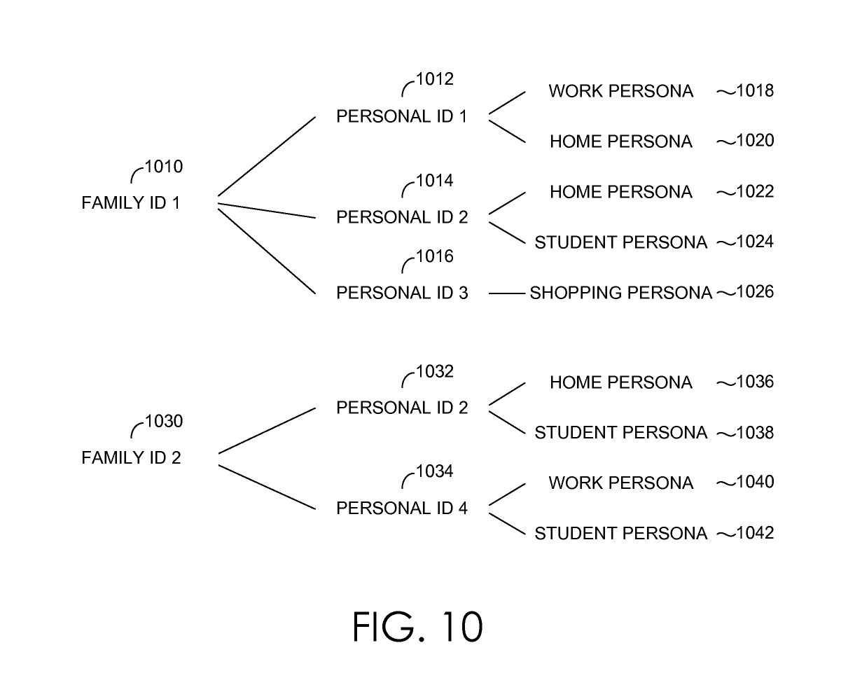

FIG. 10 provides an overview of the relationship between family identities, personal identities, and various personas. FIGS. 2-9 will describe various methods of building and using these entities. As can be seen, FIG. 10 depicts family identity 1010 and family identity 1030. Family identification 1010 comprises personal identity 1012, personal identity 1014, and personal identity 1016. Family identity 1030 includes personal identity 1014 and personal identity 1034. In part, this illustrates that a single personal identity 1014 may be part of two different family identities.

Each personal identity may be associated with one or more personas. A persona is a group of user activities or interests having a common theme or subject matter. For example, logging into a work email, entering work related queries, and visiting a professionally oriented social network site could all be grouped into a work persona. Further, devices used to perform these activities could be part of the work persona.

Personal identity 1012 is associated work persona 1018 and home persona 1020. As the name suggest, work persona 1018 may be associated with activities done at work or on behalf of an employer. Home personas may represent work done for personal reasons. For example, personal finance or shopping could be associated with a home persona. In other embodiments, a home persona or a work persona could be more granular, such as a shopping for kids persona.

Personal identity 1014 includes home persona 1022 and student persona 1024. Personal identity 1016 includes shopping persona 1026. As mentioned, the shopping persona could be a subdivision of a home persona.

Personal identities may be associated together as a family identity. The family identity associates personal identities that view content, or have the potential to view content, together through a shared device. For example, a group of personal identities that all view content through a game console or laptop may be associated as a family identity. A purpose of the family identity is to track content viewed by multiple people. A second purpose is to target advertising appropriately to the entire audience when a device is being shared. For example, advertising may be targeted based on a common interest associated with each personal identity in the family. Other rules may be used to make sure that private interests of individual personal identities are not used to select an advertisement. Rules may also be used to make sure advertisements are age appropriate for young audience members.

In family identity 1030, personal identity 1014 is associated with the same persona as described previously. Personal identity 1034 is associated with work persona 1040 and student persona 1042. Notice that both of the personal identities within family identity 1030 are associated with a student persona. This could indicate a reason for their relationship is that they are part of a student organization. This illustrates that a family identity does not necessarily have to be a family in the traditional sense. As used herein, family just means a group. No actual family is required. For example, family identity 1030 could relate personal identities associated with students that are roommates at college. In another example, the personal identities could be grouped as a family because they are associated with a club or other organization that shares computing devices and at times views content simultaneously.

Referring now to FIG. 2, a block diagram is provided illustrating an exemplary computing system 200 in which embodiments of the present invention may be employed. Generally, the computing system 200 illustrates an environment in which advertisement-targeted personas may be generated according to an applicable contextual environment of a user.

Among other components not shown, the computing system 200 generally includes a persona generator 210, a data store 212, a tracking function 216, and an advertisement distinguishing function 218, all in communication with one another via a network 220. The network 220 may include, without limitation, one or more local area networks (LANs) and/or wide area networks (WANs). Such networking environments are commonplace in offices, enterprise-wide computer networks, intranets and the Internet. Accordingly, the network 220 is not further described herein.

It should be understood that any number of persona generators, data stores, tracking functions, and advertisement distinguishing functions may be employed in the computing system 200 within the scope of embodiments of the present invention. Each may comprise a single device/interface or multiple devices/interfaces cooperating in a distributed environment. The components/modules illustrated in FIG. 2 are exemplary in nature and in number and should not be construed as limiting.

The data store 212 is configured to store data associated with a user of one or more devices. Specifically, data store 212 may include target data, described in detail below. The data store 212 may be an activity log storing information about a user's online identities, browsing history, search history, and other online activities. In embodiments, the data store 212 is configured to be searchable for one or more of the items stored in association therewith.

The persona generator 210 is configured to generate personas to be used by advertisers to provide targeted advertisements. The personas are an aggregation of identities and activities associated with a theme or contextual environment. A persona allows advertisers to target not only a specific user, but the applicable contextual environment of that user. As will be further explained below, a contextual environment may include various environments associated with a user, such as a home environment. As illustrated, the persona generator 210 includes an input component 228, analyzing component 230, determining component 232, and generating component 234. In some embodiments, the persona generator 210 includes an identifying component 236. In other embodiments, the persona generator 210 includes an output component 238.

Through the analysis of online activity data, a persona may be associated with a specific user. The online activity data may be associated with multiple devices associated with a user. The association of a persona with a user may be based on distinctive behaviors, such as page visits and searches, which are time and location specific. The link between personas and a personal identity is maintained by detecting shared identifies like IP addresses, cookie-based ids, device ids, and where available, data explicitly provided by the user. Additionally, data may be provided explicitly by the user to develop an association between a persona and a user identity. Data explicitly provided by the user includes linked online accounts, contact lists, and the ability for a user to specific a device as belonging for a specific persona.

The input component 228 of the persona generator 210 is configured to receive data for use in generating a persona. Typically, the input component 228 receives data from data store 212. However, the receiving component 228 may receive data from other sources as well, such as from the user of one or more devices, from the one or more devices themselves, or other locations within and outside network 200. For example, a user could explicitly create a persona and associate it with themselves or others. The data received by input component 228 may be received directly and without involvement of data store 212.

The analyzing component 230 of persona generator 210 is configured to analyze the data received by input component 228 and organize the online activities by personal identity or family identity.

The determining component 232 determines one or more contextual environments associated with the user based on the analysis provided by analyzing component 230. Exemplary characteristics of the one or more contextual environments are described below. For example, the determining component may determine that the user's activities fall broadly into a work, home, and shopping context. As mentioned, a persona could be created for each of these contexts.

The generating component 234 is configured to generate a persona associated with user according to applicable contextual environment. For example, the generating component 234 may associate information taken from the online activity log with the appropriate persona. The actual persona may be created from a template. For example, a work template may have fields that specify that type of work performed by the user, devices used to do work, work IP addresses, and time when work is done. Work search and browsing history may also be linked to the persona.

The identifying component 236 is configured to identify advertisements that correspond to persona; such advertisement may be called an “identified persona advertisement.” The identifying component may first determine which persona is presently active. Once the persona is picked, information from the persona is used to select a relevant advertisement. For example, if the work persona indicates that the user has been searching for phone plans while at work (and possible also at home), then an advertisement for a new smart phone might be selected for display on the work device. If the home persona showed a recent history of vacation related searches, then a travel advertisement could be selected when the home persona was determined to be the present persona.

The output component 238 is configured to communicate the identified persona advertisements to a component that presents them to the user. The advertisement presented to a user may be referred to as “presented persona advertisements.” Further, the output component may provide other data relating to the identified person advertisements, presented persona advertisements, analyzed data, determined contextual environments and generated personas to components both inside and outside network 200, such as tracking function 216. The data provided by the output component may include, specifically, identification data and/or presentation data, described in detail below.

Online activity data includes, but is not limited to, Internet protocol addresses, age, gender, geolocation, and browser cookies of a user. Identification data includes data related to the target data and persona associated with the identified persona advertisement. Presentation data includes data related to a time, location, persona and device associated with the presentation of a presented persona advertisement.

A persona is an entity associated with a user and a contextual environment related to the user. As previously stated, a persona allows advertisers to target not only a specific user, but the applicable context related to the user. For example, a user may be associated with a desktop computer at a user's home and a laptop computer at user's work. The user's use of the desktop computer at home would be associated with a user's home environment. The user's use of the laptop at work would be associated with a user's work environment. The home environment and work environment are examples of two different contextual environments, a home contextual environment and a work contextual environment. Under the home contextual environment, advertisements related to home aspects, such as cleaning or cooking, may be more applicable to the user than other advertisements. Under the work contextual environment, advertisements related to business and economics may be more applicable to the user than other advertisements. Contextual environments are not limited to physical locations of a user as a contextual environment includes any environment associated with a user. Examples of various contextual environments include, but are not limited to, sports, leisure, shopping, home, work, gym, restaurant, flying, and vacation. Further, contextual environments includes device context, such as a phone, gaming system or computer. For example, a sports contextual environment may be determined based on the user's frequent access to sport related websites.

Personas are developed based on the user and a contextual environment associated with the user. For example, a user associated with a vacation contextual environment would be associated with a vacation persona. Consequently, the advertisements presented to the user would relate both the user and the contextual environment associated with the user. In some embodiments, a user may explicitly declare the type of environment to which they are associated. For instance, a user may identify a device as a work device, or identify certain time bands as “work” time bands. Further, a user may declare certain identities or user log-ins as “work” identities or “leisure” identities. In other embodiments, behavior affinity to temporal and spatial aspects of internet usage may be used in developing a persona. For example, a user may browse entertainment MSN pages during leisure time but always issues technical queries BING at work. From such behavioral affinity, a leisure and a work persona may be generated.

Advertisements associated with a similar contextual environment but different users may vary. For example, a leisure persona may be provided different advertisements based on the age of a user, wherein the age of the user is one of the analyzed target factors. User A may be 18 years old and associated with a leisure contextual environment, while user B may be 65 years old and also associated with a leisure contextual environment. Both user A and user B would be associated with leisure personas, however the advertisements presented to each user may vary. User A may receive advertisements about college campus events, while user B may receive advertisements about retirement community events.

FIG. 3 shows a schematic diagram of a home contextual environment and a work contextual environment associated with a user. The home contextual environment includes a laptop A 310, user A 312, and cell phone A 314. The work environment includes tablet B 320, user A 312 and cell phone A 314. The home contextual environment is associated with laptop A 310 and cell phone A 314. The work contextual environment is associated with tablet B 320 and the cell phone A 314. Both environments are associated with user A 312. A home persona may be associated with the home contextual environment and user A 312, while a work persona may be associated with the work contextual environment and user A 312. Advertisements relating to the user's home may be provided on laptop A 310, while advertisements relating to the user's work may be provided on tablet B 320. Advertisements for either could be presented on the phone 314 depending on which contextual environment appears appropriate.

The appropriate device to associate to a user's persona at a particular moment in time may be determined by analyzing several persona factors, to be described further below. An example of a persona factor is location. For instance, cell phone A of FIG. 3 may be located in a user's home at night and a user's workplace during the day. When cell phone A is associated with the user's home contextual environment, advertisements related to a user's home may be provided. When the same cell phone A is associated with the user's work contextual environment, advertisements related to a user's work may be provided.

Persona factors include a location of a user, device, time of day, router information, user settings of a device, user settings of a person, user settings of a contextual environment, and security settings associated with a network to which a device may be connected. The user settings of a device may include, but are not limited to: time of day advertisements may be presented, types of advertisements allowed and/or prohibited, and types of advertisers allowed and/or prohibited. The user settings of a persona may include, but are not limited to: the types of personas allowed and/or prohibited to be associated with a user, type of contextual environments a persona may be created for, and times of day persona may be utilized. The user settings of a contextual environment may include, but are not limited to: types of contextual environments allowed and/or prohibited to be associated with a user. Persona factors may be provided explicitly by the user. Persona factors may also be implicitly provided through an analysis of settings, including user settings and device settings, of the one or more devices associated with the user. The persona settings may be stored locally on the one or more devices themselves, at the data store 212 or at other components, not shown in FIG. 2. The persona settings may be applied by the receiving component 230, analyzing component 232, determining component 234, generating component 236, identifying component 238 and/or outputting component 240.

The tracking function 216 may operate on any type of computing device, such as the computing device 100 described with reference to FIG. 1. Generally, the tracking function 216 includes an input component 222, storing component 224 and output component 226. The input component 222 is configured to receive input from the persona generator 210, the data store 212, and the advertisement distinguishing function 218. The input component 222 may receive input from other sources as well, such as a user of one or more devices and/or the one or more devices themselves. Content that may be received by the input device 222 includes identification data and presentation data. Presentation data describes advertisements shown to users identified by the identification data.

The advertisement comparing function 218 is configured to define a set of advertisements not previously presented to a user according to comparison factors. The advertisement comparing function 218 helps advertisers maintain the applicability and effectiveness of advertisements presented to a user by helping to provide advertisement that are new to the user, regardless of the persona associated with the new advertisement. The advertisement comparing function 218 includes an input component 240, identifying component 242, comparing component 244, defining component 246 and presenting component 248.

The input component 240 of advertisement comparing function 218 may receive data from the persona generator 210, the tracking function 216 and/or other components of other devices not shown. The identifying component 242 identifies personas, identified persona advertisements, and presented persona advertisements. The comparing component 244 compares identified persona advertisements and presented persona advertisements. The defining component 246 defines a set of persona advertisements according to the comparison factors. The output component 248 presents the set of persona advertisements.

Comparison factors include time period and personas. For instance, an advertisement presented a certain period of time, such as within the last 4 hours, would not be presented again to a user. In another instance, an advertisement presented to a user under a work persona, would not be presented again to a user under a leisure persona and/or within a certain period of time. The period of time may be determined based on seconds, minutes, hours, days, weeks or any other increment of time.

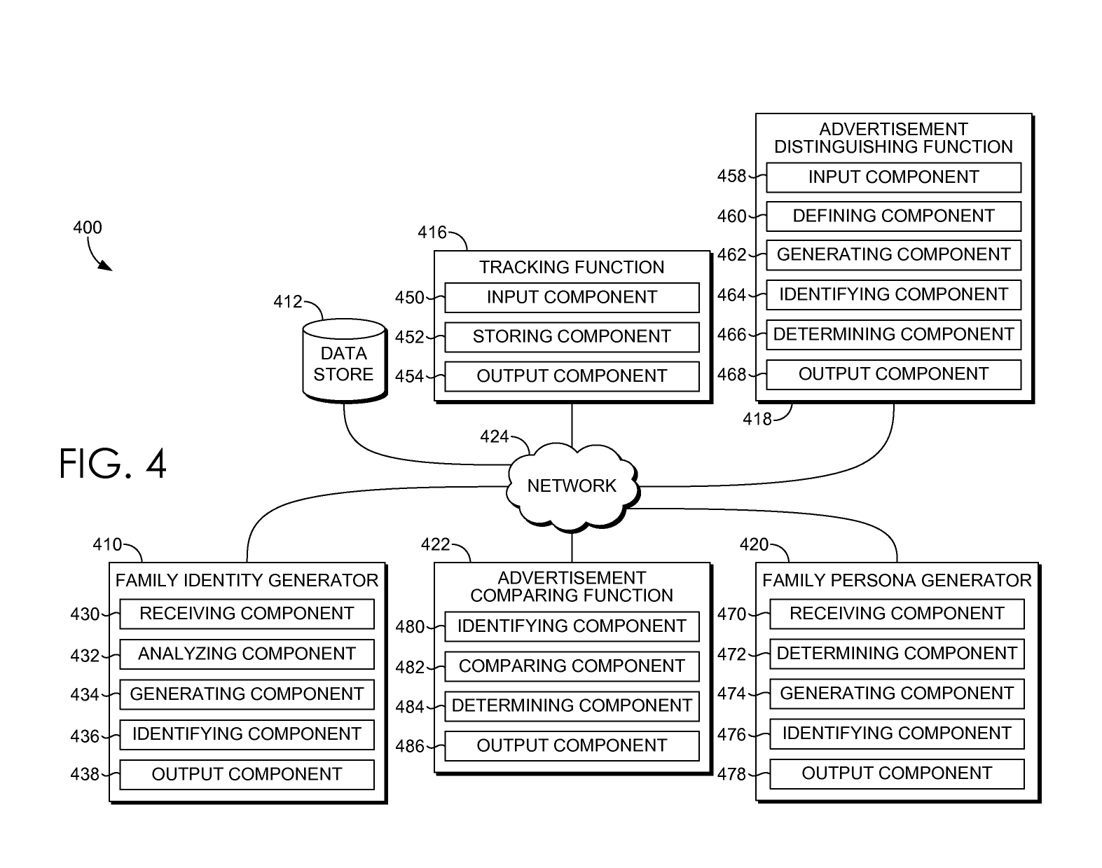

Turning to FIG. 4, a block diagram is provided illustrating an exemplary computing system 400 in which embodiments of the present invention may be employed. Generally, the computing system 400 illustrates an environment in which family identities may be generated in order to provide advertisers the ability to present advertisements targeting a set of consumers.

A family identity is associated with a set of users, which may be referred to as “family users.” Each user is associated with a personal identity. In some embodiments, the family users include at least two users that are associated with of at least one device. In other embodiments, the family users include at least two users, where each user is associated with at least one device; however two users may not be associated with the same device. In some embodiments, a family identity allows advertisers to provide advertisements targeted to a set of closely related people, such as a family household. A family identity may be used when the identity of an individual user is not easily determined. For instance, a gaming console involves multiple persons signing on to the gaming console in order to participate in a game. Often times, persons may sign on under someone else's log-in, thus making it difficult to determine which person is actually associated with the device at a particular time. A family identity allows advertisements to be identified and presented that are applicable to multiple users.

The computing system 400 generally includes a family identity generator 410, a data store 412, a tracking function 416, an advertisement distinguishing function, 418, an advertisement comparing function 420 and a family identity persona generator 422, all in communication with one another via network 424. Network 424 is similar to network 220, as network 424 may include, without limitation, one or more local area networks (LANs) and/or wide area networks (WANs). Such networking environments are commonplace in offices, enterprise-wide computer networks, intranets and the Internet. Accordingly, the network 424 is not further described herein. It should be understood that any number of family identity generators, data stores, tracking functions, advertisement distinguishing functions, advertisement comparing functions, and family identity person generators may be employed in the computing system 400 within the scope of embodiment of the present invention. Each may comprise a single device/interface or multiple devices/interfaces cooperating in a distributed environment.

The data store 412 is similar to data store 212 and is configured to store online activity and identity data associated with a user of one or more devices. Such data may include, without limitation, Internet protocol addresses, age, gender, geolocation, and browser cookies. In embodiments, the data store 412 is configured to be searchable for one or more of the items stored in association therewith.

The family identity generator 410 is configured to generate family identities. As illustrated in FIG. 4, the family identity generator 410 includes an input component 430, analyzing component 432, and generating component 434. In some embodiments, the family identity generator 410 includes identifying component 436. In other embodiments, the family identity generator 410 includes output component 438.

The input component 430 of the family identity generator 410 is configured to receive data for use in generating a family identity. In some embodiments, the data received by the input component 430 is activity data, as previously described. The input component 430 may receive data from data store 412. However, the receiving component 430 may receive data from other sources as well, such as from a user of one or more devices, from the one or more devices themselves, or other locations.

The analyzing component 432 of the family identity generator 410 is configured to analyze the data received by receiving component 430 and look for relation ships between personal identities. When common signals characteristics appear in online activity data associated with multiple personal identities, then the personal identities may be associated as a family. For example, if personal identities are associated with the same IP address or device then the personal identities may be related as a family.

The generating component 434 is configured to generate a family identity based on the analyzed data. The family identity groups personal identities together to jointly track advertisement viewing and to help with selecting advertisements. The family identity may also include characteristics the personal identities have in common. For example, if home personas associated with two different personal identities in the family, show an interest in baseball, then an interest in baseball may be associated with the family identity.

The identifying component 436 is configured to identify advertisements applicable to the family identity. The advertisements identified as being applicable to the generated family identity may be referred to as “identified family identity advertisements.” In some embodiments, the identifying component 436 applies one or more determining factors, described in detail below, to the analyzed data and generated family identity in order to determine applicable advertisements for the family identity. The output component 438 is configured to present identified family identity advertisements. Advertisements that have been presented to a user may be referred to as “presented family identity advertisements.” Additionally, the output component 438 is configured to provide identification and presentation data, described in detail below, to other components both inside and outside network 400, such as tracking function 416.

A family identity may be developed based on associating target data with various users. In some embodiments, a family identity may be based on explicit declaration of one or more of the users. For instance, users may declare associations to one another in a Terms of Service form. In other instances, users may declare family grouping in applications such as WINDOWS 8 people application, phone people hub, Messenger, and Skype.

In other embodiments, a family identity may be based on the use of the same device by multiple signed-in identities. For example, in the Xbox, there is a possibility of getting all the signed in identities and treating them as a family unit.

In further embodiments, a family identity may be based on a variety of signals of anonymous identities. Some of these are co-presence of either a geo-location, attached with a same IP address, such as a router, attached with a same device, or other techniques for identity correlation pointed out in related art but specifically tuned and optimized to find a family unit. In some embodiments, the identity correlation may be bolstered by using time of use as another signal. For example, two identities are seen as making requests to MICROSOFT services from the same IP address at the same time in a persistent manner over a period of time, one on an Xbox and the other on a tablet. Based on such information, the two identities may be associated with one another to create a family identity.

Determining factors include the frequency of a user on a specific device, corresponding browser history between at least two of the family users, browser cookie, audio signal, visual signal, a declared dominant user, user settings, and security settings.

For instance, if user A searches for a vacation destination and user B also searches for a vacation destination, the corresponding browser history of vacation destinations may be applied to identifying and presenting family identity advertisement related to vacation destinations. In another example, a user may be a declared dominant user, such that the dominant user's browser history and/or user settings may be weighted when identifying and presenting family identity advertisements.

The tracking function 416 is similar to tracking function 216 and may operate on any type of computing device, such as the computing device 100 described with reference to FIG. 1. Generally, the tracking function 416 includes an input component 450, storing component 452, and output component 454. The input component 450 is configured to receive input from the family identity generator 410, data store 412, advertisement distinguishing function 418, advertisement comparing function 420, and family identity persona generator 422, and/or other components (not shown). The input component 450 may receive input from other sources as well, such as a user of one or more devices and/or the one or more devices themselves. Content that may be received by the input device includes, but is not limited to, identification data and presentation data. The storing component 452 store the data received at the input component 450. The output component 454 may provide data to any of the components within computing system 400 and/or component in other systems, such as system 200 and 600.

The advertisement distinguishing function 418 is configured to provide an advertisement to a user that has not been previously provided to a user as a part of the family identity. The advertisement distinguishing function 418 includes an input component 458, defining component 460, generating component 462, determining component 464 and output component 466.

The input component 458 of the advertisement distinguishing function 418 receiving data from tracking device 416 and/or any other device within network 400. The defining component 460 defines a specific user of the family users. The generating component 462 generates a user identity that is associated with the specific user. The identifying component 464 identifies advertisements corresponding to the user identity. Advertisements identified as corresponding to user identities may be referred to as “identified user advertisements.” The identifying component 464 also identifies presented family identity advertisements. The determining component 466 determines a subset of the identified user advertisements associated that include advertisements that are different from the presented family identity advertisements. In some embodiments, the subset includes only advertisements that have not been presented to the family identity. In other embodiments, the subset includes a percentage of advertisements different from the advertisements presented to the family identity.

The output component 468 of the advertisement distinguishing function 418 is configured to present the determined subset of advertisements associated with the user identity. Additionally, the output component 468 is configured to provide identification data and presentation data, described below, associated with the user identity and family identity, to other components both inside and outside network 400, such as tracking function 416.

The family persona generator 420 is configured to generate a persona related to a family identity and a contextual environment. A family persona is similar to the persona described above, but related to a family identity instead of an individual user. The family persona allows advertisements to be presented to a group of individuals associated with a family identity according to contextual environments. The family persona generator 420 includes an input component 470, determining component 472, generating component 474, identifying component 476 and output component 478.

The input component 470 of the family persona generator 420 is configured to receive input from the data store 412. However, input component 470 may receive data from other sources as well, such as from the family identity generator 410, tracking function 416, a user of one or more devices, from the one or more devices themselves, or from other locations. The determining component 472 determines a contextual environment associated with a family identity based on the data received at the input component 470. The generating component 474 generates a family persona. The identifying component 476 identifies advertisements applicable to the generated family persona. Advertisements identified as being applicable to a generated family person may be referred to as “identified family persona advertisements.” The output component 478 presents the identified advertisements. Advertisements presented in relation to a family persona may be referred to as “presented family persona advertisements.” The output component 478 also provides data to various components including, but not limited to, data store 412, tracking function 416, advertisement distinguishing function 418, advertisement comparing function 422, and other components not shown. The output component 478 may provide data related to identified advertisements and presented advertisements, such as the identification data and presentation data.

The advertisement comparing function 422 provides for the comparison between identified family persona advertisements and presented family persona advertisements. The comparing device 422 allows for advertisements to be presented to users according to the comparison factors, as described above. The advertisement comparing function 422 generally includes an input component 480, identifying component 482, comparing component 484, determining component 486 and output component 488.

The input component 480 may receive input from data store 412, tracking function 418, advertisement distinguishing function 418, family identity generator 410 and/or family persona generator 420. The input component may receive input from other locations not shown. In some embodiments, the input received by the input component 480 includes identification data and presentation data, as described above, related to family personas.

The identifying component 482 identified family personas, advertisements identified as relating to the identified family personas and presented advertisements related to the identified family personas. The comparing component 484 compares the presented family persona advertisements to identified family persona advertisements. The determining component 486 determines a subset of advertisements according to the comparison factors. The output component 488 may present the subset of advertisements. The output component may also provide data related to the identified advertisements, including the subset of advertisements, presented advertisements, including the presented subset of advertisements and other data related to the comparison of advertisements. The data provided by the output component may include, specifically, identification data and presentation data.

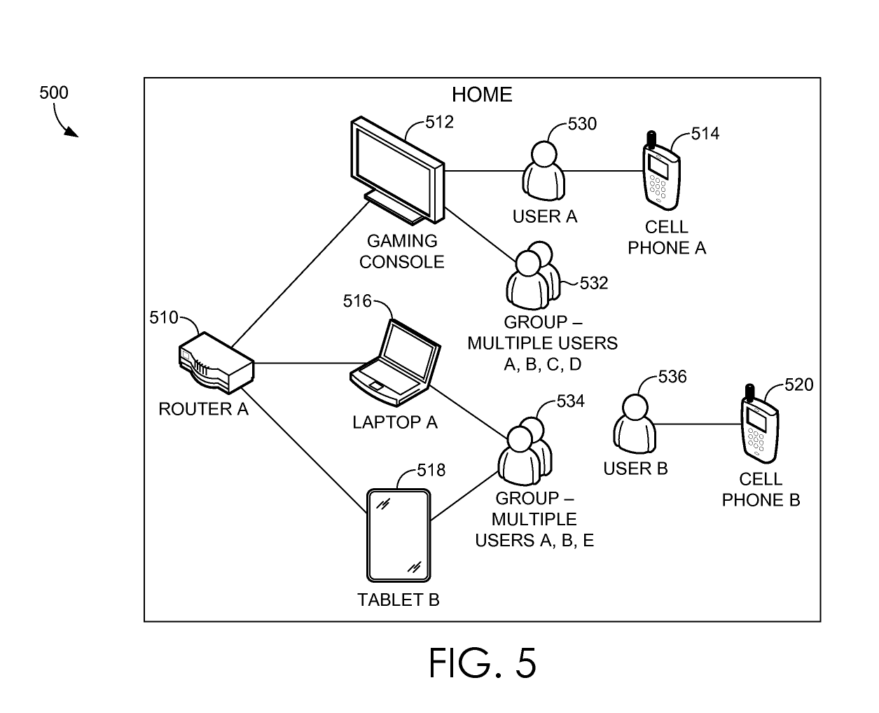

Turning now to FIG. 5, a schematic diagram of an exemplary family household in which a family identity may be generated. The schematic diagram of FIG. 5 includes a router 510, gaming console 512, cell phone A 514, laptop A 516, tablet B 518, cell phone B 520, user A 530, group of multiple users A, B, C, and D 534, group of multiple users A, B, and E 534 and user B 536. As can be seen in FIG. 5, a group of multiple users may be associated with at least one device within the family household. For instance, the group of multiple users A, B, C, and D 532 may be associated with the gaming console 512 while users the group of multiple users A, B and E 534 may be associated with the tablet B 518. Both the gaming console 512 and tablet B 518 are associated with Router A 510. Based on the association between the router 510, gaming console 512, and tablet B 518, a family identity may be associated with A, B, C, D, and E, or any combination thereof. Based on the generated family identity, advertisements may be identified that correspond to the family identity.

In some embodiments, the identified family identity advertisements may be presented on any of the devices associated with any of the users. For instance, a family identity advertisement may be presented on cell phone A even though cell phone A is associated only with user A. In other embodiments, family identity advertisements may be presented only on devices associated with specific users. For instance, a family identity may be generated in relation to users A, B, C, and D. Advertisements associated with the generated family identity related to users A, B, C and D may then be presented on the gaming console, as the gaming console is associated with users A, B, C, and D. In another example, a family identity may be generated in relation to users A B, and E. Advertisements associated with the generated family identity related to users A, B, and E may then be presented on the tablet A because tablet A is associated with users A, B, and E.

In some embodiments, personas may be associated with family identities as the family identities may be related to various contextual environments. For instance, a family identity may be associated users A, B, and E, where users A, B, and E use laptop A and tablet A. Laptop A may be used in a home office, while tablet A may be used in a child's playroom. In such instance a contextual environment of a home office may be associated with laptop A, while a contextual environment of a child's playroom may be associated with tablet A. Further a home office persona and child's playroom persona may both be associated with the family identity related to users A, B, and E. As such, advertisements relating to business may be presented on laptop A, while kid-friendly advertisements may be presented on tablet A.

Additionally, as described in detail above in relation to a persona associated with an individual user, a persona may be associated with the environment in which a device and/or user is located. In the previously described instance, if laptop A were to be moved from the home office to the child's playroom, advertisements relating to the contextual environment of a child's playroom would be presented on laptop A.

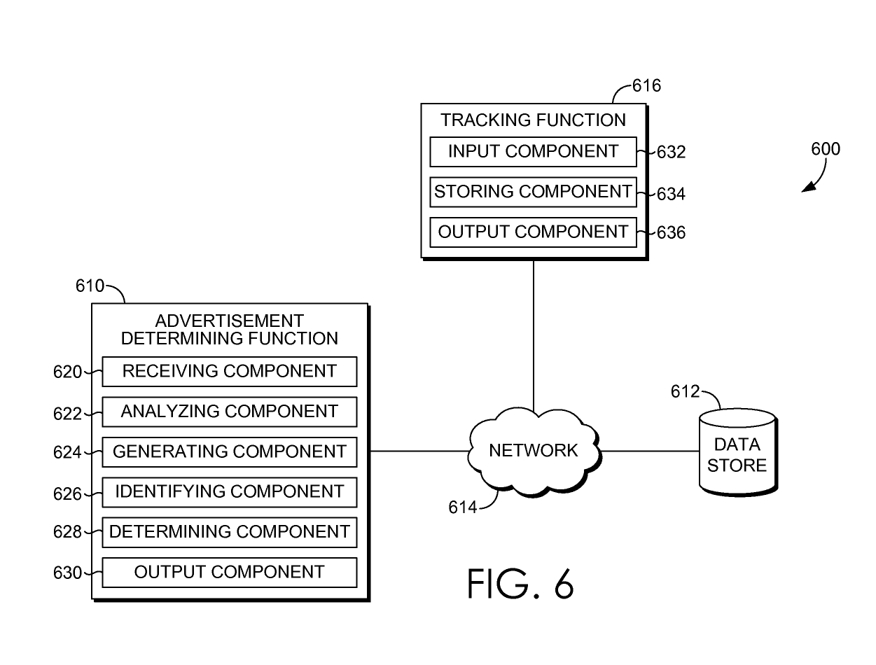

Turning now to FIG. 6, a block diagram is provided illustrating an exemplary computing system 600 in which embodiments of the present invention may be employed. Generally, the computing system 600 illustrates an environment in which appropriate advertisements may be determined based on target factors, described in detail below. Computing system 600 generally includes network 614, data store 612 and advertisement determining function 610. Network 614 is similar to networks 220 and 424 and will not be described further herein. Additionally, data store 610 is similar to data store 212 and 412 and will not be described further herein.

Advertisement determining function 610 provides a determination of appropriate advertisements to be presented based on target factors. Target factors include the level of confidence in a family identity and the level of confidence in a user identity. Advertising determining device includes an receiving component 620, analyzing component 622, generating component 624, identifying component 626, determining component 628 and output component 630.

The receiving component 620 receives data from data store 612, from a user, and/or from devices associated with a user. Additionally, receiving component 620 may receive data from any of the components found in network 200 and/or network 400. The analyzing component 622 analyzes the target data and identifies family users associated with at least one device and a specific user of the family users. The family of users includes at least two users. The generating component 624 generates a family identity associated with the family users. The generating component 624 also generates a user identity associated with the user. The identifying component 626 identifies an advertisement corresponding to the family identity and a user advertisement corresponding to the user identity. The determining component analyzes target factors and determines whether to present the family identity advertisement or the user advertisement. The output component 630 presents the determined advertisement. The output component 630 may also provide data related to the identified advertisements, presented advertisements, and target factors to the data store 612, tracking function 616.

In some embodiments, the determination of whether to provide advertisements based on a user identity or a family identity may occur in a hierarchical manner. The hierarchy includes three different levels of user identity, which are: (1) Explicit Persistent User Identity, (2) Stable Identity, and (3) Family stable Identity.

The Explicit Persistent User Identity is related to any logged on user identity. Under the Explicit Persistent User Identity the level of confidence in a specific user identity is high. The Stable Identity is associated with the identity for a current request. The Stable Identity does not have significant targeting data. Under the Stable Identity, the level of confidence in a user identity is not as high as the level of confidence in the Explicit Persistent User Identity. (Inventors: please provide more information on how a Stable Identity is different from an Explicit Persistent User Identity.) The Family Stable Identity is associated with a user identity on a shared device. A Family Stable Identity may be used to resolve an average identity if an Explicit Persistent User Identity may not be determined.

The tracking function 616 is similar to tracking function 416 and 216 and may include any type of computing device, such as the computing device 100 described with reference to FIG. 1, for example. Generally, the tracking function 616 includes an input component 632, storing component 634, and output component 636. The input component 632 is configured to receive input from the advertisement determining function 610, data store 612, any or all components of computing system 400, any or all components of computing system 600, and/or other components (not shown). The input component 632 may receive input from other sources as well, such as a user of one or more devices and/or the one or more devices themselves. Content that may be received by the input device includes, but is not limited to, identification data and presentation data. The storing component 634 store the data received at the input component 632. The output component 636 may provide data to any of the components within computing system 600 and/or component in other systems, such as system 200 and 400.

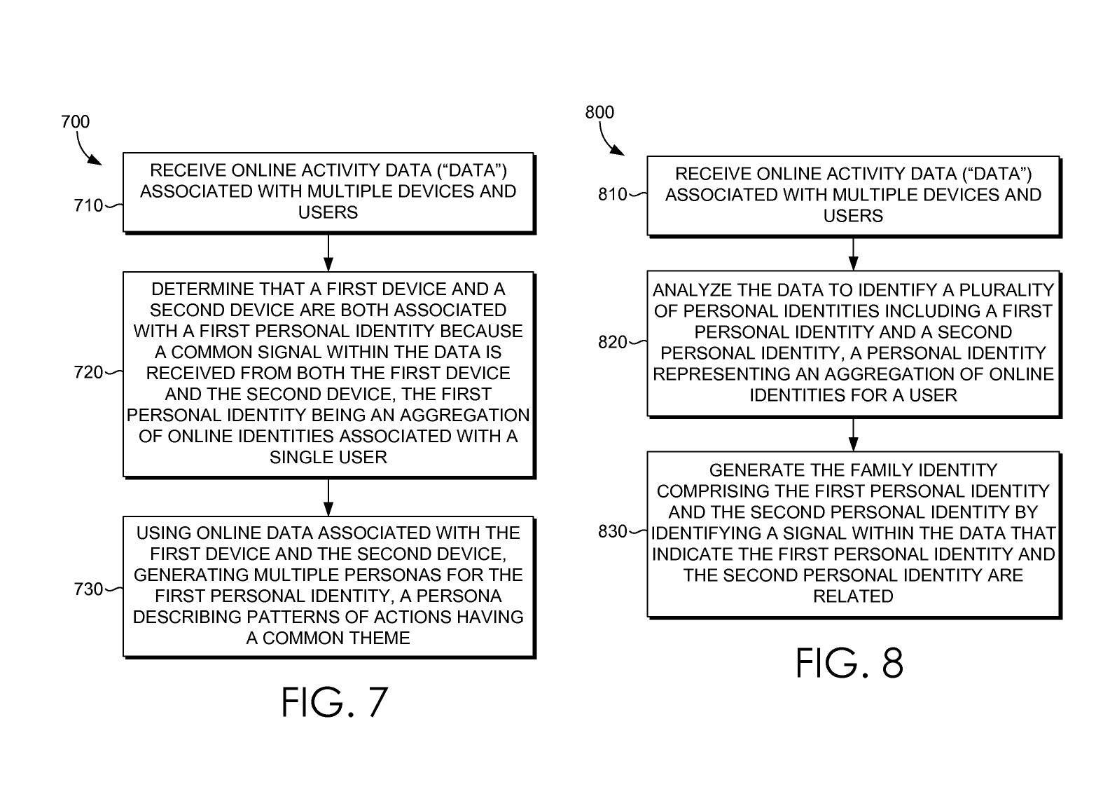

Turning now to FIG. 7, a method 700 for generating a cross-device personal identity is shown, in accordance with an embodiment of the present invention. A cross-device personal identity is a personal identity that aggregates online activities and identities associated with at least two of user's devices. One or more of the devices may be shared with other users.

At step 710, online activity data associated with multiple devices and users is received. The online activity data may be stored in an activity log that tracks browsing history, search history, transmission of user IDs, and other information.

At step 720, it is determined that a first device and a second device are both associated with a first personal identity because a common signal in the data is received from both the first device and the second device. For example, a user could log in to the same email account from both the first device and the second device. A series of activities are analyzed to identify similarities within the signal data. Once a confidence level is reached, the first and second devices are determined to be associated with the same personal identity, forming a cross-device personal identity.

The cross-device personal identity allows advertisers and other entities to track content viewed by the user on both devices. This can limit the amount of times a user sees, and ignores, an advertisement. The combined usage data from the two devices is also helpful to more accurately target advertisements to the users based personas generated from data gathered from multiple devices.

At step 730, online data associated with both the first and second device is used to generate a persona for the personal identity. The persona describes patterns of actions having a common theme. As mentioned previously, a user could have a work persona, a home persona, a shopping persona, a leisure persona, or other personas. The unifying theme may be the purpose for or context in which the actions are performed. These have been described previously.

In one embodiment, the second device is determined to be associated with a second personal identity in addition to the first personal identity. Using this information, possibly in combination with other signal data, the first personal identity and the second personal identity are assigned to a family identity because they share the device. Other information such as how frequently they share the device and the type of device that is shared may also be used to confirm the two entities should be associated.

Turning now to FIG. 8, a method 800 for generating a family identity is shown, in accordance with an embodiment of the present invention. At step 810, online activity data associated with multiple devices and users is received. At step 820, the data is analyzed to identify a plurality of personal identities, including a first personal identity and a second personal identity. A personal identity represents an aggregation of online identities for a user. For example, the personal identity may aggregate the user's online identity in a social network with the online identity used to access an email account. A user may have multiple online identities. In addition, activities performed may also be associated with the personal identity.

At step 830, the family identity comprising the first personal identity and the second personal identity is generated by identifying a signal within the data that indicates the first personal identity and the second personal identity are related. For example, the signal could be receiving data packets from personal devices associated with the first personal identity and the second personal identity that have the same IP address. In addition to simply receiving such packets having the same IP address, the frequency with which this occurs may also be considered before joining two personal identities into a family identity. Other factors, such as sharing a single device, also support joining the personal identities into a family identity.

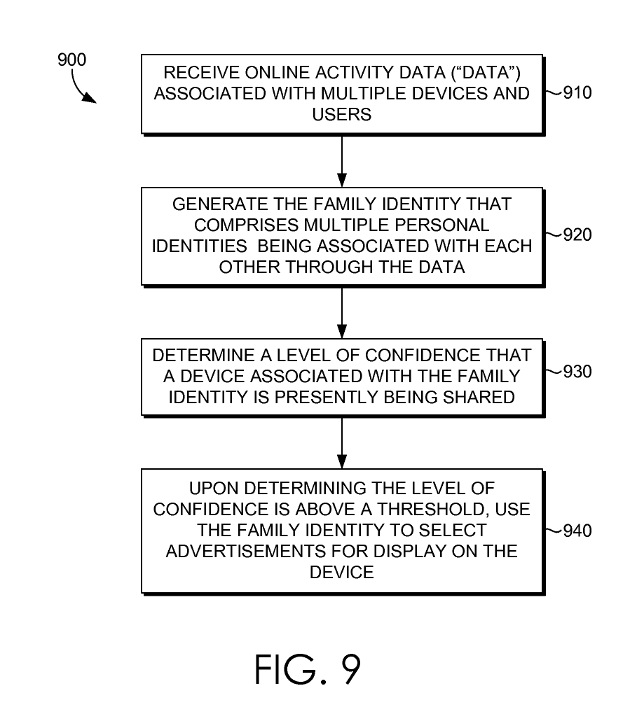

Turning now to FIG. 9, a method 900 for generating a family identity is shown, in accordance with an embodiment of the present invention. At step 910, online activity data associated with multiple devices and users is received. At step 920, the family identity is generated by analyzing the data. The family identity comprises multiple personal identities associated with each other. Once the data indicates a confidence that a family identity should be generated, the individual personal identities are added. Over time, personal identities may be added to or subtracted from a family based on subsequently received user data. For example, when signal data received from one personal identity no longer overlaps or indicates a connection with other family members, then personal identity may be removed. Accordingly, family relationships may be dynamically updated by recalculating the confidence factors. Once the factor falls below a confidence, the personal identity associated with the confidence is removed. If the family only has two persona identities, then the family identity may be deleted.

At step 930, a level of confidence indicating that a device associated with the family identity is presently being shared is determined is above a threshold confidence. A level of confidence indicates that two or more people are sharing the device at the present time. For example, two users associated with personal identities within the family identity may be playing a game on a game console together. The confidences can be adjusted to avoid certain situations, sometimes in conjunction with user preferences. For example, a shared device such as a TV or laptop may have an assumed sharing state unless there is a very high confidence that only a single user is interacting with the device. For example, a single user could log in to a particular account and designate that they are using the device in a private setting.

In one embodiment, the type of activity being performed is analyzed to ascertain whether the device is being shared. Activities such as playing a two player game or viewing media content may indicate sharing. On the other hand, reading news articles or searching for information may be a solitary activity supporting the idea that the device is not being shared. In some cases, multiple signals may be analyzed to determine a likelihood of sharing. For example, when multiple devices associated with the different personal identities within a family are simultaneously sending data packets having the same IP address, that indicates that multiple people are at least in proximity to each other and could be sharing a device.

In contrast, when the signal data indicates that each family member is in a different location, such as indicated by GPS data received from a mobile device or even IP addresses that are associated with different locations, then the confidence that an individual personal identity is using a shared device privately may be increased.

At step 940, upon determining the level of confidence above a threshold, and thus indicating that the device is being shared, the family identity is used to select advertisements for display on the device. As mentioned, the family identity may have a family persona or otherwise be associated with characteristics that are derived from individual personas. In another embodiment, the personas associated with individual personal identities within the family are dynamically analyzed to ascertain a common interest. For example, if the personas associated with two of the users indicate they are planning a vacation, then a vacation-related advertisement may be shown to both users.

In one embodiment, work personas are explicitly excluded from consideration when a family setting is indicated. In addition, interests classified as private may also be excluded from use when picking an advertisement in a shared setting. An example of a private interest may be job searching. In another embodiment, the present contextual environment is first determined. For example, if a shared device is used in the work context, then advertisements associated with non-work personas may be excluded from consideration while at the work persona is the present context. Once selected, the advertisement may be output for display to the user. Advertising metrics such as click-through rate and conversion rate may be tracked across a family identity as well as by personal identities within the family.

Many different arrangements of the various components depicted, as well as components not shown, are possible without departing from the spirit and scope of embodiments of the present invention. Embodiments of the present invention have been described with the intent to be illustrative rather than restrictive. Certain features and subcombinations are of utility and may be employed without reference to other features and subcombinations and are contemplated to be within the scope of the claims.

The invention claimed is:

1. One or more computer-readable media having computer-executable instructions embodied thereon that, when executed, perform a computer-implemented method for generating a cross-device personal identity, the method comprising:
receiving online activity data (“data”) associated with multiple devices and users;
determining that a first device and a second device are both associated with a first personal identity because a common signal within the data is received from both the first device and the second device, the first personal identity being an aggregation of online identities associated with a single user; and
using online data associated with the first device and the second device, generating a persona for the first personal identity, the persona describing patterns of actions having a common theme.

2. The computer-readable media of claim 1, the method further comprising:
determining that the second device is associated with a second personal identity in addition to the first personal identity; and
assigning the first personal identity and the second personal identity to a family identity because they share the second device.

3. The computer-readable media of claim 2, the method further comprising:
receiving a request to present an advertisement on the second device, which is a device shared by the first personal identity and the second personal identity;
determining that the second device is currently being shared;
retrieving an advertisement that is associated with the family identity.

4. The computer-readable media of claim 3, the method further comprising:
assigning the first personal identity and a third personal identity, which is not associated with either the first device or the second device, to the family identity because a signal within the data links the first personal identity and the third personal identity.

5. The computer-readable media of claim 4, wherein the signal comprises an IP address.

6. The computer-readable media of claim 1, wherein the common theme is one or more of leisure, sports, business, and home.

7. One or more computer-readable media having computer-executable instructions embodied thereon that, when executed, perform a computer-implemented method for generating a family identity, the method comprising:
receiving online activity data (“data”) associated with multiple devices and users;
analyzing the data to identify a plurality of personal identities including a first personal identity and a second personal identity, a personal identity representing an aggregation of online identities for a user; and
generating the family identity comprising the first personal identity and the second personal identity by identifying a signal within the data that indicate the first personal identity and the second personal identity are related.

8. The computer-readable media of claim 7, wherein the signal comprises receiving data packets sent from the same IP address.

9. The computer-readable media of claim 7, wherein the signal comprises:
corresponding browser history between the first personal identity and the second personal identity.

10. The computer-readable media of claim 7, wherein the signal is an explicit instruction defining a first online id associated with the first personal identity as related in a family relationship with a second online id associated with the second personal identity.

11. The computer-readable media of claim 7, wherein the signal is an explicit instruction defining the first personal identity as related in a family relationship with the second personal identity.

12. The computer-readable media of claim 7, the method further comprising
identifying a device that is shared by the first personal identity and the second personal identity and designating the device as a family device.

13. The computer-readable media of claim 12, the method further comprising:
tracking advertisements shown on the family device as viewed by both the first personal identity and the second personal identity.

14. The computer-readable media of claim 7, the method further comprising:
generating, for the first personal identity, multiple personas that describe patterns of actions having a common theme that are performed online.
generating, for the second personal identity, multiple personas that describe patterns of actions having a common theme that are performed online;
receiving a request to present an advertisement on a device shared by the first personal identity and the second personal identity;
determining that the device is currently being shared by the first personal identity and the second personal identity; and
retrieving an advertisement that is compatible with both a first persona assigned to the first personal identity and a second persona assigned to the second personal identity.

15. The computer-readable media of claim 14, the method further comprising:
blocking retrieval of an advertisement that is associated with only the first persona or only the second persona.

16. A method for generating a family identity, the method comprising:
receiving online activity data (“data”) associated with multiple devices and users;
generating the family identity that comprises multiple personal identities being associated with each other through the data;
determining a level of confidence that a device associated with the family identity is presently being shared; and
upon determining the level of confidence is above a threshold, using the family identity to select advertisements for display on the device.

17. The method of claim 16, wherein the family identity is based on interests shared by the multiple personal identities associated with the family identity.

18. The method of claim 16, wherein the data used to associate the multiple identities to the family identity comprises sharing the device.

19. The method of claim 16, wherein the data used to associate the multiple identities to the family identity comprises devices associated with each of the personal identities sharing a common IP address.

20. The method of claim 16, wherein the method further comprises associating a first personal identity from the multiple personal identities with a different family identity, thereby associating the first personal identity with two different family identities simultaneously.
